(19) United States
(12) Patent Application Publication
(10) Pub. No.: US 2019/0243908 A1
(43) Pub. Date: Aug. 8, 2019

(54) STORAGE SERVER AND ADAPTIVE PREFETCHING METHOD PERFORMED BY STORAGE SERVER IN DISTRIBUTED FILE SYSTEM

(71) Applicant: ELECTRONICS AND TELECOMMUNICATIONS RESEARCH INSTITUTE, Daejeon (KR)

(72) Inventors: Sang-Min LEE, Daejeon (KR); Hong-Yeon KIM, Daejeon (KR); Young-Kyun KIM, Daejeon (KR)

(21) Appl. No.: 16/199,036

(22) Filed: Nov. 23, 2018

(30) Foreign Application Priority Data
Feb. 5, 2018 (KR) 10-2018-0014147

(51) Int. Cl. G06F 17/30

(52) U.S. Cl. CPC G06F 17/30132; G06F 17/30194

(57) ABSTRACT

Disclosed herein are a storage server and an adaptive prefetching method performed by the storage server in a distributed file system. An adaptive prefetching method includes receiving, by a management request processing unit of a storage server, a stream generation request from a client, sending, by the management request processing unit, a stream identifier and information about an I/O worker, which correspond to the stream generation request, to the client, receiving, by the management request processing unit, a read request from the client, inserting, by the management request processing unit, the read request into a queue of the I/O worker corresponding to the read request, performing, by the I/O worker, adaptive prefetching for the read request using an identifier of a file object of stream information corresponding to the read request, and transmitting, by the I/O worker, data that is read by performing adaptive prefetching to the client.

### CROSS REFERENCE TO RELATED APPLICATION

This application claims the benefit of Korean Patent Application No. 10-2018-0014147, filed Feb. 5, 2018, which is hereby incorporated by reference in its entirety into this application.

### BACKGROUND OF THE INVENTION

### 1. Technical Field

The present invention relates generally to adaptive prefetching technology in which various execution environments are taken into consideration in a distributed file system, and more particularly, to prefetching technology that is adaptable to the type of a storage device and network delay time.

### 2. Description of the Related Art

Recently, distributed file systems have been widely used in various fields. For example, Gluster and Ceph for cloud data service, the Google File System (GFS) and Hadoop Distributed File System (HDFS) for searching and social network analysis, and Lustre and PanFS in supercomputing fields have come to be widely used.

A distributed file system has various execution environments depending on the application field thereof. Such a distributed file system may be composed of a single storage server to several hundreds to several thousands of servers depending on the scale thereof. Further, different network delay times inevitably occur as the number of hops of switches between a client and a user server varies. Also, for data transfer or backup, a client may be located far away from a storage server on the network, by which a long delay time may occur.

Further, in response to performance requirements, the distributed file system may use various storage devices. For example, a hard disk may be used to obtain a wide storage space, and a Solid-State Drive (SSD) or Nonvolatile Random Access Memory (NVRAM) may be used to realize high performance, and the user file system of the client may access various storage devices.

Meanwhile, the biggest issue with current file systems is to provide high sequential read performance. In particular, in a distributed file system, since a read operation is frequently requested by multiple clients, the performance of multiple streams (i.e. concurrent read streams) (sequential file read in multiple processes) is far more important than the performance of a single read stream (sequential file read in a single process).

Therefore, there is required the development of technology that can guarantee high performance and can also guarantee the performance of multiple sequential read operations as well as a single sequential read operation by performing a sequential read operation in consideration of various execution environments of the distributed file system. In connection with this, Korean Patent No. 10-1694988 discloses a technology related to “Method and Apparatus for reading data in a distributed file system”.

### SUMMARY OF THE INVENTION

Accordingly, the present invention has been made keeping in mind the above problems occurring in the prior art, and an object of the present invention is to assign an individual stream to a single I/O worker and allow the I/O worker to take exclusive charge of the individual stream, thus obtaining performance identical to that of a local file system.

Another object of the present invention is to solve a problem in which, as the number of multiple streams is increased, performance is deteriorated, thus obtaining maximum performance while minimizing the deterioration of random read performance in different execution environments.

A further object of the present invention is to satisfy the performance required by an application at lower expense than when using a conventional distributed file system, thus remarkably decreasing initial construction expenses.

In accordance with an aspect of the present invention to accomplish the above objects, there is provided an adaptive prefetching method, the adaptive prefetching method being performed by a storage server in a distributed file system, including receiving, by a management request processing unit of the storage server, a stream generation request from a client, sending, by the management request processing unit, a stream identifier and information about an Input/Output (I/O) worker, which correspond to the stream generation request, to the client, receiving, by the management request processing unit, a read request from the client, inserting, by the management request processing unit, the read request into a queue of the I/O worker corresponding to the read request, performing, by the I/O worker, adaptive prefetching for the read request using an identifier of a file object of stream information corresponding to the read request; and transmitting, by the I/O worker, data that is read by performing adaptive prefetching to the client.

Sending the stream identifier and the I/O worker information may include generating, by the management request processing unit having received the stream generation request, a file object including a prefetched context by opening a file corresponding to a stream generated by the client, and generating, by the management request processing unit, stream information related to an identifier of the generated file object and the stream identifier, and selecting an I/O worker to take exclusive charge of an individual stream corresponding to the stream identifier.

The adaptive prefetching method may further include receiving, by the management request processing unit, a stream deletion request from the client, and deleting the file object including the prefetched context by closing an identifier of a file object of a stream corresponding to the stream deletion request.

The adaptive prefetching method may further include calculating, by the management request processing unit, a required processing time, which is a time taken to process the stream generation request, wherein sending the stream identifier and the I/O worker information is configured such that the management request processing unit transmits result information of the stream generation request to the client, the result information including at least one of the stream identifier, the I/O worker information, information about the required processing time, and dummy data.

The client may be configured to calculate a required request-response time, which is a time taken to receive the result information of the stream generation request after sending the stream generation request, and calculate a maximum number of asynchronous readahead operations based on the required request-response time and the required processing time.

Sending the stream identifier and the I/O worker information may be configured to transmit the dummy data, the stream identifier, and the I/O worker information to the client, wherein the dummy data has a size identical to a readahead size of a storage device connected to the storage server.

Receiving the read request from the client may be configured to receive a read request corresponding to a maximum number of asynchronous readahead operations from the client, which calculates the maximum number of asynchronous readahead operations based on at least one of a network delay time between the client and the storage server and information about a storage device connected to the storage server.

Inserting the read request into the queue of the I/O worker may be configured to insert the read request into a queue of an I/O worker that takes exclusive charge of an individual stream corresponding to the stream identifier of the read request, among multiple I/O workers, and then allow the I/O worker to process the read request.

Receiving the read request from the client may be configured to receive the read request that includes at least one of the stream identifier, information about the I/O worker that takes exclusive charge of the individual stream corresponding to the stream identifier, readahead position information, and readahead size information.

In accordance with another aspect of the present invention to accomplish the above objects, there is provided an adaptive prefetching method, the adaptive prefetching method being performed by a client in a distributed file system, including sending, by the client, a stream generation request to a storage server, receiving, by the client, a stream identifier and information about an I/O worker information, which correspond to the stream generation request, from the storage server, sending, by the client, a read request corresponding to a maximum number of asynchronous readahead operations to the storage server, and receiving, by the client, data that is read when the I/O worker corresponding to the read request performs adaptive prefetching, from the storage server.

Sending the read request may be configured such that the client calculates the maximum number of asynchronous readahead operations based on a time taken to receive the read data after sending the stream generation request and a time taken for the storage server to process the stream generation request, and sends the read request corresponding to the calculated maximum number of asynchronous readahead operations to the storage server.

In accordance with a further aspect of the present invention to accomplish the above objects, there is provided a storage server, including a management unit for receiving a stream generation request from a client and inserting the stream generation request into a queue of a management request processing unit in a distributed file system, the management request processing unit for sending a stream identifier and information about an I/O worker, which correspond to the stream generation request, to the client, receiving a read request from the client, and inserting the read request into a queue of an I/O worker corresponding to the read request, and an I/O worker for performing adaptive prefetching for the read request using an identifier of a file object of stream information corresponding to the read request and transmitting data that is read by performing adaptive prefetching to the client.

The management request processing unit may generate a file object including a prefetched context by opening a file corresponding to a stream generated by the client, generate stream information related to an identifier of the generated file object and the stream identifier, and select an I/O worker to take exclusive charge of an individual stream corresponding to the stream identifier.

The management unit may receive a stream deletion request from the client and delete the file object including the prefetched context by closing an identifier of a file object of a stream corresponding to the stream deletion request.

The management unit may calculate a required processing time, which is a time taken for the management request processing unit to process the stream generation request, and transmit result information of the stream generation request to the client, the result information including at least one of the stream identifier, the I/O worker information, information about the required processing time, and dummy data.

The client may calculate a required request-response time, which is a time taken to receive the result information of the stream generation request after sending the stream generation request, and calculate a maximum number of asynchronous readahead operations based on the required request-response time and the required processing time.

The management request processing unit may transmit the dummy data, the stream identifier, and the I/O worker information to the client, wherein the dummy data has a size identical to a readahead size of a storage device connected to the storage server.

The management request processing unit may receive a read request corresponding to a maximum number of asynchronous readahead operations from the client, which calculates the maximum number of asynchronous readahead operations based on at least one of a network delay time between the client and the storage server and information about a storage device connected to the storage server.

The management request processing unit may insert the read request into a queue of an I/O worker that takes exclusive charge of an individual stream corresponding to the stream identifier of the read request, among multiple I/O workers, and then allow the I/O worker to process the read request.

The management request processing unit may receive the read request that includes at least one of the stream identifier, information about the I/O worker that takes exclusive charge of the individual stream corresponding to the stream identifier, readahead position information, and readahead size information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a storage server according to an embodiment of the present invention;

FIG. 2 is a flowchart illustrating an adaptive prefetching method performed by the storage server according to an embodiment of the present invention;

FIG. 3 is a flowchart illustrating a method for managing streams to perform adaptive prefetching in a distributed file system according to an embodiment of the present invention;

FIG. 4 is a configuration diagram illustrating an adaptive prefetching method according to an embodiment of the present invention; and

FIG. 5 is a diagram for explaining a process for performing adaptive prefetching in a client according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that these embodiments are not intended to limit the present invention to specific disclosure forms and that they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here including technical or scientific terms have the same meanings as terms generally understood by those skilled in the art to which the present invention pertains. The terms identical to those defined in generally used dictionaries should be interpreted as having meanings identical to contextual meanings of the related art, and are not to be interpreted as having ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

When sequential read processing in a distributed file system is analyzed to improve the performance of individual streams in various execution environments, a client is executed on a Virtual File System (VFS) in most distributed file systems in order to support a Portable Operating System Interface (POSIX). A readahead (prefetch) size which is requested by the client from a storage server may be ra_{c}(ra_{c}i), and an additional asynchronous readahead request ra_{c}i+1 may be made by the VFS.

Further, the storage server, having received such a request, performs a first read operation Read(ra_{c},i) to primarily process ra_{c}i. Next, first read data is sent to the client Send(ra_{c},i)_{sc} at the same time that a second read operation Read(ra_{c},i+1) is performed to secondarily process ra_{c}i+1. Also, in response to the second read request ra_{c}i+1, a readahead operation (raₛ) occurs even in the storage server.

Meanwhile, a local file system may realize the maximum performance by sending a read request so that the storage device is not idle in order to improve sequential read performance.

$$Read ( {ra}_{c} , i ) + \{ \begin{matrix}Read ( {ra}_{c} , i + 1 ) + Read ( {ra}_{s} , \frac{( i + 1 ) * {ra}_{c}}{{ra}_{s}} + 1 ) \\ Send ( {ra}_{c} , i ) s \to c\end{matrix} \qquad ( 1 )$$

In Equation (1), when a read request ra_{c}i+2 arrives at the storage server through a send operation (Send(req(ra_{c},i+2))_{c→s}) before two read operations

$$( Read ( {ra}_{c} , i + 1 ) + Read ( {ra}_{s} , \frac{( i + 1 ) * {ra}_{c}}{{ra}_{s}} + 1 ) )$$

are completed, the storage server may sequentially perform the operations of reading from the storage device and sending to the network in parallel with each other. Therefore, the distributed file system may sequentially perform read operations without being idle, as in the case of the local file system.

When the condition (i.e. Power-to-Noise Ratio (PNR) condition) given in the following Equation (2) is satisfied, the client of the distributed file system may continuously send read requests to the storage device of the storage server.

$$T [ {Send ( {ra}_{c} , i )}_{s \to c} + {Send ( req ( {ra}_{c} , i + 2 ) )}_{c \to s} ] \leq T [ Read ( {ra}_{c} , i + 1 ) + Read ( {ra}_{s} , \frac{( i + 1 ) * {ra}_{c}}{{ra}_{s}} + 1 ) ] . \qquad ( 2 )$$

When the storage device of the distributed file system is a high-speed storage device, the time

$$T [ Read ( {ra}_{c} , i + 1 ) + Read ( {ra}_{s} , \frac{( i + 1 ) * {ra}_{c}}{{ra}_{s}} + 1 ) ]$$

is shortened, thus making it difficult to satisfy the PNR condition. Further, when a network delay time between the client and the storage server is lengthened, T[Send(ra_{c},i)_{s→c}+Send(req(ra_{c},i+2))_{c→s}] is increased, thus making it difficult to satisfy the PNR condition.

In order to overcome the limitation of a conventional distributed file system in various execution environments, the PNR condition of Equation (2) is changed to the following Equation (3) on the assumption that ra_{c} and raₛ are equal to each other.

T[Send(raₛ,i)_{s→c}+Send(req(raₛ,i+2))_{c→s}]≤T[Read(raₛ,i)]+T[Read(raₛ,i+1)] (3)

Further, since T[Read((i+1)*raₛ,raₛ)]≈T[Read((i+2)*raₛ,raₜ)] is satisfied, the PNR condition is represented by the following Equation (4):

$$\frac{T [ {Send ( {ra}_{c} , i )}_{s \to c} + {Send ( req ( {ra}_{c} , i + 2 ) )}_{c \to s} ]}{2} \leq T [ Read ( {ra}_{s} , i ) ] \qquad ( 4 )$$

In Equation (4), the value of the left term is halved due to the additional read request ra_{c}i+1 from the client, and thus the PNR condition may be more easily satisfied. When this scheme is extended and the number of readahead operations (i.e. the number of readahead operations) α of the client is increased, an adaptive prefetching technique, such as that shown in the following Eauation (5), may be obtained.

$$\frac{T [ {Send ( {ra}_{c} , i )}_{s \to c} + {Send ( req ( {ra}_{c} , i + 2 ) )}_{c \to s} ]}{1 + α} \leq T [ Read ( {ra}_{s} , i ) ] \qquad ( 5 )$$

That is, in order to overcome the limitation of the conventional distributed file system in various execution environments, the storage server according to the embodiment of the present invention may perform prefetching using the number of readahead operations α satisfying Equation (5), as represented by the following Equation (6):

$$\frac{T [ {Send ( {ra}_{c} , i )}_{s \to c} + {Send ( req ( {ra}_{c} , i + α ) )}_{c \to s} ]}{\frac{{ra}_{s}}{{RB}_{dev}}} - 1 \leq α \qquad ( 6 )$$

That is, the storage server according to the embodiment of the present invention may acquire high-speed sequential read performance by increasing the number of readahead operations α in the case of a high-speed storage device. Further, the storage server according to the embodiment of the present invention may obtain the maximum performance of the storage device by increasing the number of readahead operations a in accordance with an increased delay time between the client and the storage server.

Meanwhile, in order to improve the performance of multiple streams in the local file system, a Completely Fair Queuing (CFQ) I/O scheduler is mainly used. CFQ, which is intended to equally distribute a single storage device into multiple processes, is configured to distribute a predetermined time slice to a single processor (or thread), thus enabling the processor to exclusively occupy the storage device for a predetermined period. Due thereto, since only one of the multiple streams is assigned to the processor for the predetermined period, the processor may perform one seek operation and sequential transfer operations, and the multi-stream performance of the local file system may be improved.

However, in the distributed file system, the advantage of CFQ cannot be applied due to an Input/Output (I/O) processing structure. The storage server is composed of a single request queue and multiple I/O workers. Requests received from the client are stored in the request queue, and each of the I/O workers fetches the stored requests one by one from the request queue and processes the fetched requests of the client.

Because of this processing scheme, the advantage of CFQ cannot be applied to the conventional distributed file system, and each I/O worker causes a large number of seek operations by processing an arbitrarily selected streaming request, among multiple streams. Due thereto, even if CFQ is used, performance similar to that of a random read operation may be obtained. Therefore, the storage server according to the embodiment of the present invention may assign an individual stream to a single I/O worker and allow the I/O worker to take exclusive charge of the individual stream, thus obtaining the same performance as a local file system.

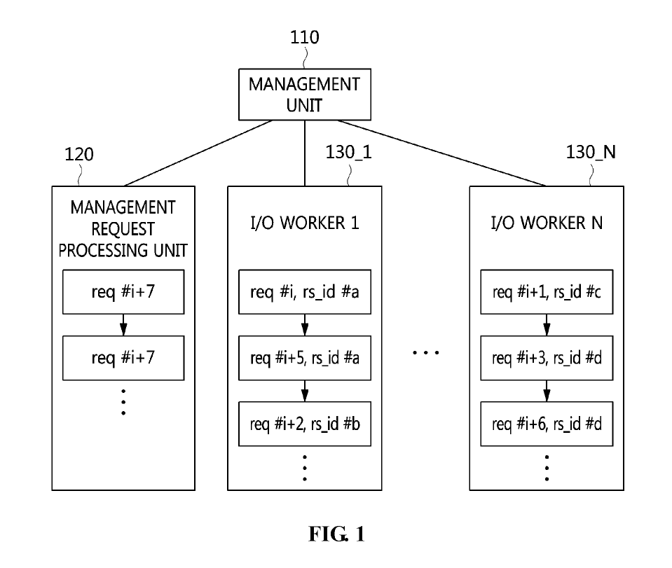

FIG. 1 is a block diagram illustrating the configuration of a storage server according to an embodiment of the present invention.

As illustrated in FIG. 1, a storage server 100 for performing adaptive prefetching in a distributed file system includes a management unit 110, a management request processing unit 120, and one or more I/O workers 130.

The storage server 100 according to the embodiment of the present invention may be configured as illustrated in FIG. 1 in order to solve the problem of performance deterioration occurring in multiple streams, and may be configured such that I/O workers have respective request queues, unlike the single request queue of the conventional distributed file system.

For example, requests for stream #a may be stored and processed in the queue of I/O worker #1, and requests for stream #d may be stored and processed in the queue of I/O worker #n. Here, the distribution of requests into multiple queues may be performed by the management unit 110, which is the network reception processor (i.e. dispatcher) of the storage server 100.

The storage server 100 according to the embodiment of the present invention may prevent the I/O workers 130 from processing requests for other streams that are not designated by utilizing a multi-queue distribution scheme, thus obtaining high-multi-stream performance, as in the CFQ of the local file system.

Also, the storage server 100 may be provided with a queue separate from the I/O queues of the I/O workers so as to promptly process management requests, such as requests for file generation and deletion and for stream generation and deletion.

In FIG. 1, the management unit 110 receives a stream generation request from the client in the distributed file system and inserts the stream generation request into the queue of the management request processing unit 120. The management unit 110 may receive a stream deletion request from the client, close an identifier of the file object of the stream corresponding to the received stream deletion request, and delete a file object including a prefetched context.

Further, the management unit 110 may calculate a required processing time, which is the time taken for the management request processing unit 120 to process the stream generation request, and may transmit result information of the stream generation request, which includes at least one of a stream identifier, information about the corresponding I/O worker, information about the required processing time, and dummy data, to the client.

The management unit 110 may transmit information about the required processing time to the client, thus allowing the client to calculate the maximum number of asynchronous readahead operations based on the required processing time. Here, the client may calculate a required request-response time, which is the time taken to receive the result information of the stream generation request after sending the stream generation request, and may calculate the maximum number of asynchronous readahead operations based on at least one of the required request-response time and the required processing time.

Next, the management request processing unit 120 sends the stream identifier and information about the I/O worker, corresponding to the stream generation request, to the client, and receives a read request from the client. In this case, the management request processing unit 120 may transmit dummy data having the same size as the readahead size of the storage device connected to the storage server, the stream identifier, and the I/O worker information to the client.

Further, the management request processing unit 120 may receive a read request corresponding to the maximum number of asynchronous readahead operations from the client that calculates the maximum number of asynchronous readahead operations based on at least one of the network delay time between the client and the storage server and information about the storage device connected to the storage server.

Here, the management request processing unit 120 may receive a read request including at least one of a stream identifier, information about an I/O worker that takes exclusive charge of an individual stream corresponding to the stream identifier, readahead position information, and a readahead size.

Further, the management request processing unit 120 inserts the read request into the queue of the I/O worker 130 corresponding to the read request. At this time, the management request processing unit 120 may insert the read request into the queue of the I/O worker that takes exclusive charge of an individual stream corresponding to the stream identifier of the read request, among the multiple I/O workers, thus allowing the corresponding I/O worker to process the read request.

Furthermore, the management request processing unit 120 generates a file object including a prefetched context by opening a file corresponding to the stream generated by the client, and generates stream information related to an identifier of the generated file object and the stream identifier. In addition, the management request processing unit 120 selects an I/O worker that will take exclusive charge of the individual stream corresponding to the stream identifier.

Finally, the I/O worker 130 performs adaptive prefetching for the read request using the file object pointer of the stream information corresponding to the read request, and transmits data that is read by performing adaptive prefetching to the client.

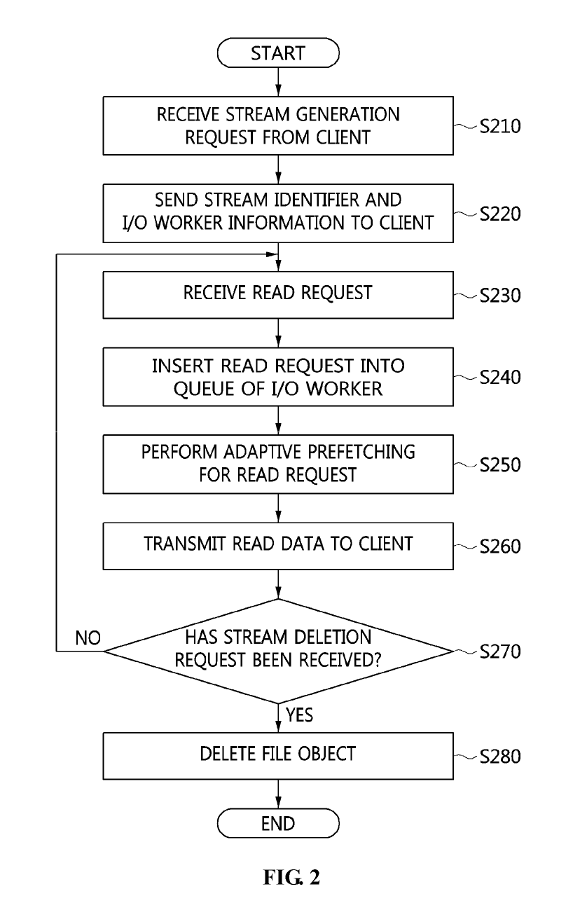

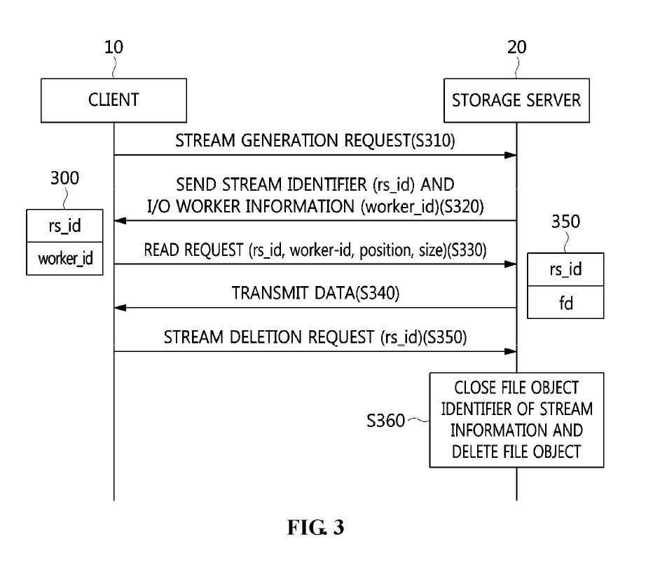

Below, an adaptive prefetching method in a distributed file system according to an embodiment of the present invention will be described later in detail with reference to FIGS. 2 and 3.

FIG. 2 is a flowchart illustrating an adaptive prefetching method performed by the storage server according to an embodiment of the present invention.

First, the storage server 100 receives a stream generation request from a client at step S210. The storage server 100, having received the stream generation request, sends a stream identifier and information about an I/O worker to the client at step S220.

Next, the storage server 100 receives a read request from the client, having received the stream identifier and the I/O worker information, at step S230, and inserts the read request in the queue of the I/O worker at step S240.

Then, the storage server 100 performs adaptive prefetching for the read request at step S250 and transmits the data that is read by performing adaptive prefetching to the client at step S260.

Meanwhile, when a stream deletion request is received from the client (in the case of “Yes”) at step S270, the storage server 100 may delete the corresponding file object at step S280.

FIG. 3 is a flowchart illustrating a method for managing streams to perform adaptive prefetching in a distributed file system according to an embodiment of the present invention.

In order to improve the performance of each individual stream, a readahead operation (raₛ) must be performed by a VFS on the file of a server corresponding to each stream. Therefore, a storage server 20 may manage each stream, as illustrated in FIG. 3.

First, a client 10 sends a stream generation request to the storage server 20 at step S310. When a file is opened and one stream is generated, the client 10 sends a stream generation request to the storage server 20. Further, the storage server 20 sends a stream identifier rs_id and I/O worker information worker_id, corresponding to the stream generation request, to the client 10 at step S320.

The management request processing unit of the storage server 20 may generate a file object, including a prefetched context, by opening the file corresponding to the stream generation request. Further, the management request processing unit generates server management stream information 350, which is information about an identifier fd of the generated file object and the stream identifier rs_id, and selects an I/O worker worker_id that will take exclusive charge of the corresponding stream.

The storage server 20 sends the stream identifier rs_id and the I/O worker information worker_id, corresponding to the stream generation request, to the client 10. At step S320, the client 10, having received the stream identifier rs_id and the I/O worker information worker_id, generates and manages client management stream information 300.

The client 10 may maintain the stream identifier rs_id and the I/O worker information worker_id in the corresponding stream, and may send a read request, including the stream identifier rs_id and the I/O worker information worker_id, to the storage server 20 whenever a sequential read request for the stream is received.

That is, the client 10 that manages the client management stream information 300 sends the read request to the storage server 20 at step S330. Here, the read request may include the stream identifier rs_id and the I/O worker information worker_id, and may further include position and size information.

The storage server 20, having received the read request, may search for server management stream information 350 matching the stream identifier rs_id of the read request, process the read request using the file object identifier fd of the server management stream information 350, and then perform a readahead operation (prefetching). Further, the storage server 20 may transmit data that is read by performing prefetching to the client 10 at step S340.

The storage server 20 inserts the read request into the queue of the I/O worker corresponding to the I/O worker information worker_id of the read request. The read request inserted into the queue is processed by the corresponding I/O worker. By searching for server management stream information 350 matching the stream identifier rs_id of the read request and processing the read request using the corresponding file object identifier fd, the storage server 20 may automatically perform a readahead operation (prefetching), and may transmit the read data to the client 10.

Meanwhile, the client 10 may send a stream deletion request including the stream identifier rs_id to the storage server 20 at step S350, and the storage server 20, having received the stream deletion request, may delete a file object by closing the file object pointer of the stream information at step S360.

When the stream deletion request is received, the storage server 20 may acquire server management stream information 350 matching the stream identifier rs_id of the stream deletion request, and may delete a file object including a prefetched context by closing the file object identifier fd of the server management stream information 350.

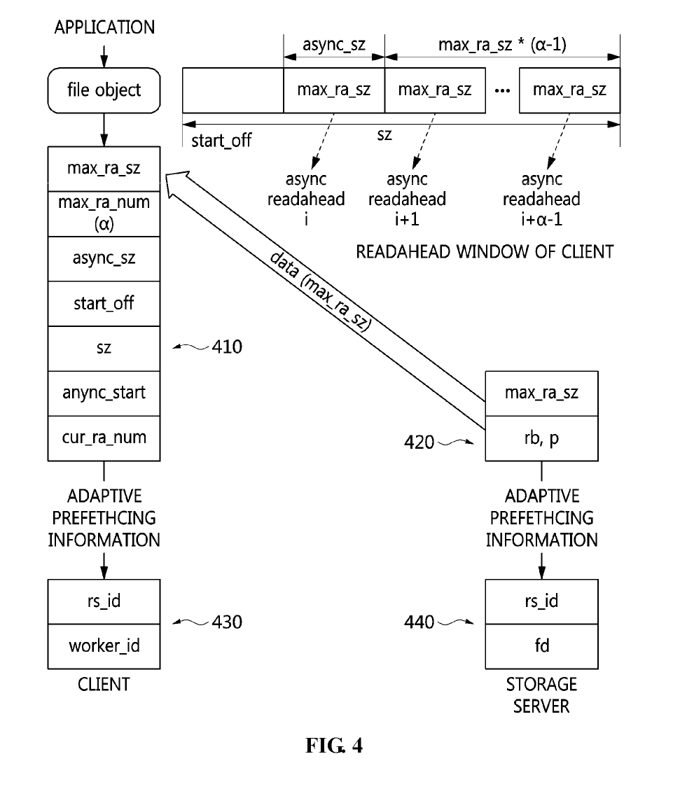

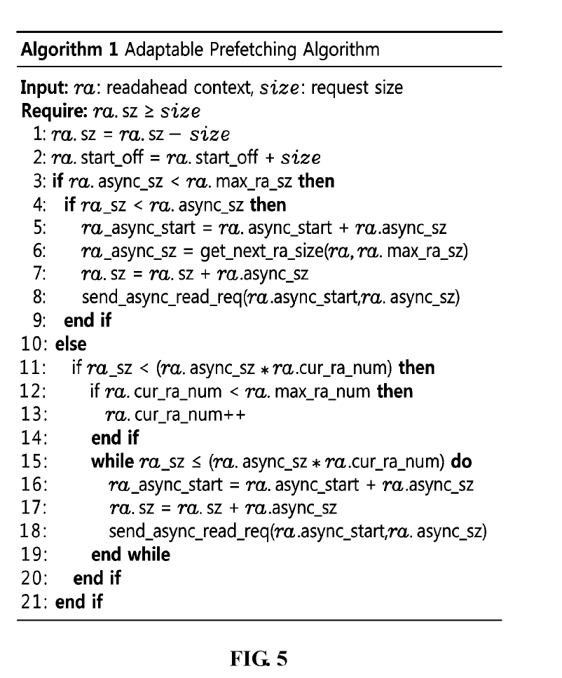

Hereinafter, an adaptive prefetching process according to an embodiment of the present invention will be described in detail with reference to FIGS. 4 and 5.

FIG. 4 is a configuration diagram illustrating an adaptive prefetching method according to an embodiment of the present invention.

As illustrated in FIG. 4, pieces of information about storage devices (readahead size max_ra_sz and read performance (Bytes/second: RB)) 420 may be set for respective storage devices in a storage server, and may be connected to server management stream information 440.

Also, a client may extract the number of readahead operations α for adaptive prefetching based on the storage device information 420. Here, the client sets the number of readahead operations α when a stream generation request occurs.

Required time T[Send(raₛ,i)_{s→c}+Send(req(raₛ,i+α))_{c→s}] is equal to the time obtained by subtracting the time T[Proc(cs)ₛ] required for processing by the server from the time T[ReqRecv(cs)_{c}] that is taken for the client to receive a response after sending the stream generation request. Therefore, the number of readahead operations a may be set using the following Equation (7):

$$\frac{T [ {ReqRecv ( cs )}_{c} ] - T [ {Proc ( cs )}_{s} ]}{\frac{max \_ra \_sz}{{RB}_{dev}}} - 1 \leq α \qquad ( 7 )$$

Further, the stream generation request is processed, as illustrated in FIGS. 2 and 3, so that the time T[ReqRecv(cs)_{c}] that is taken for the client to receive a response after sending the stream generation request and the time T[Proc(cs)ₛ] required for processing by the server may be calculated. The number of readahead operations α that satisfies Equation (7) may be extracted using information about the calculated times.

Also, the client may perform adaptive prefetching based on the extracted number of readahead operations α. In order to perform adaptive prefetching, the client may include adaptive prefetching information 410.

In the adaptive prefetching information 410, max_ra_sz denotes the readahead size raₛ of the storage device, received from the storage server, and max_ra_num denotes the maximum number of asynchronous readahead operations α, which may be a value obtained when the stream generation request is processed. Further, async_sz denotes an individual readahead size, which may be maximally increased up to max_ra_sz.

Further, start_off is a value used to determine whether or not the read request of an application is sequential, and denotes the recent read request position information of the stream, sz denotes the maximum readahead size (max_ra_sz*max_ra_num), async_start denotes information about the position at which an asynchronous readahead operation is to be performed, and cur_ra_num denotes the current number of asynchronous readahead operations, which may be maximally increased up to max_ra_num.

FIG. 5 is a diagram for explaining a process for performing adaptive prefetching in a client according to an embodiment of the present invention.

As illustrated in FIG. 5, the client may perform adaptive prefetching based on the adaptive prefetching information 410 of FIG. 4. When a readahead size is less than max_ra_sz, the client increases the readahead size in the same manner as in conventional VFS, and increases the readahead size in a manner different from that of the conventional VFS, starting from the point at which the readahead size becomes equal to or greater than max_ra_sz.

That is, the client may increase the value of cur_ra_num (i.e. the current number of asynchronous readahead operations) by 1, and may then finally increase it to max_ra_num. Here, an increase of cur ra num of 1 means that the readahead size will be increased to max_ra_sz.

Further, the client performs an asynchronous readahead operation (prefetching) depending on the readahead size. When the current readahead size sz is less than the maximum readahead size (max_ra_sz*max_ra_num), the client may perform adaptive prefetching by continuing to sequentially send an asynchronous readahead request corresponding to a size of max_ra_sz.

Conventional distributed file systems such as GFS, HDFS, and Lustre are incapable of realizing the performance expected in high-speed storage devices, or are only capable of obtaining high-speed read performance at the expense of deteriorated random read performance. Also, a problem arises in that multi-stream performance, which is the most important factor in a distributed file system, is deteriorated with an increase in the number of multiple streams.

However, the storage server and the client in the distributed file system according to the embodiment of the present invention may obtain the maximum performance while minimizing the deterioration of random read performance in different execution environments by selecting an exclusive I/O worker and performing adaptive prefetching. In accordance with the present invention, the performance required by an application may be satisfied at low expense by utilizing a storage device that is cheaper than that of a conventional distributed file system or a smaller number of servers than that of a conventional distributed file system, thus remarkably reducing initial construction expenses.

In accordance with the present invention, an individual stream is assigned to a single I/O worker to allow the I/O worker to take exclusive charge of the individual stream, thus obtaining performance identical to that of a local file system.

Further, in accordance with the present invention, there can be solved a problem in which, as the number of multiple streams is increased, performance is deteriorated, thus obtaining the maximum performance while minimizing the deterioration of random read performance in different execution environments.

Furthermore, in accordance with the present invention, the performance required by an application is satisfied at lower expense than when using a conventional distributed file system, thus remarkably decreasing initial construction expenses.

As described above, in the storage server and the adaptive prefetching method performed by the storage server in a distributed file system according to the present invention, the configurations and schemes in the above-described embodiments are not limitedly applied, and some or all of the above embodiments can be selectively combined and configured such that various modifications are possible.

What is claimed is:

1. An adaptive prefetching method, the adaptive prefetching method being performed by a storage server in a distributed file system, comprising:
receiving, by a management unit of the storage server, a stream generation request from a client and inserting the stream generation request into a queue of a management request processing unit in the storage server;
sending, by the management request processing unit, a stream identifier and information about an I/O worker, which correspond to the stream generation request, to the client;
receiving, by the management request processing unit, a read request from the client;
inserting, by the management request processing unit, the read request into a queue of the I/O worker corresponding to the read request;
performing, by the I/O worker, adaptive prefetching for the read request using an identifier of a file object of stream information corresponding to the read request; and
transmitting, by the I/O worker, data that is read by performing adaptive prefetching to the client.

2. The adaptive prefetching method of claim 1, wherein sending the stream identifier and the I/O worker information comprises:
generating, by the management request processing unit having received the stream generation request, a file object including a prefetched context by opening a file corresponding to a stream generated by the client; and
generating, by the management request processing unit, stream information related to an identifier of the generated file object and the stream identifier, and selecting an I/O worker to take exclusive charge of an individual stream corresponding to the stream identifier.

3. The adaptive prefetching method of claim 2, further comprising:
receiving, by the management unit, a stream deletion request from the client; and
deleting the file object including the prefetched context by closing an identifier of a file object of a stream corresponding to the stream deletion request.

4. The adaptive prefetching method of claim 1, further comprising:
calculating, by the management unit, a required processing time, which is a time taken to process the stream generation request,
wherein sending the stream identifier and the I/O worker information is configured such that the management request processing unit transmits result information of the stream generation request to the client, the result information including at least one of the stream identifier, the I/O worker information, information about the required processing time, and dummy data.

5. The adaptive prefetching method of claim 4, wherein the client is configured to calculate a required request-response time, which is a time taken to receive the result information of the stream generation request after sending the stream generation request, and calculate a maximum number of asynchronous readahead operations based on the required request-response time and the required processing time.

6. The adaptive prefetching method of claim 4, wherein sending the stream identifier and the I/O worker information is configured to transmit the dummy data, the stream identifier, and the I/O worker information to the client, wherein the dummy data has a size identical to a readahead size of a storage device connected to the storage server.

7. The adaptive prefetching method of claim 1, wherein receiving the read request from the client is configured to receive a read request corresponding to a maximum number of asynchronous readahead operations from the client, which calculates the maximum number of asynchronous readahead operations based on at least one of a network delay time between the client and the storage server and information about a storage device connected to the storage server.

8. The adaptive prefetching method of claim 1, wherein inserting the read request into the queue of the I/O worker is configured to insert the read request into a queue of an I/O worker that takes exclusive charge of an individual stream corresponding to the stream identifier of the read request, among multiple I/O workers, and then allow the I/O worker to process the read request.

9. The adaptive prefetching method of claim 8, wherein receiving the read request from the client is configured to receive the read request that includes at least one of the stream identifier, information about the I/O worker that takes exclusive charge of the individual stream corresponding to the stream identifier, readahead position information, and readahead size information.

10. An adaptive prefetching method, the adaptive prefetching method being performed by a client in a distributed file system, comprising:
sending, by the client, a stream generation request to a storage server;
receiving, by the client, a stream identifier and information about an I/O worker information, which correspond to the stream generation request, from the storage server;
sending, by the client, a read request corresponding to a maximum number of asynchronous readahead operations to the storage server; and
receiving, by the client, data that is read when the I/O worker corresponding to the read request performs adaptive prefetching, from the storage server.

11. The adaptive prefetching method of claim 10, wherein sending the read request is configured such that the client calculates the maximum number of asynchronous readahead operations based on a time taken to receive the read data after sending the stream generation request and a time taken for the storage server to process the stream generation request, and sends the read request corresponding to the calculated maximum number of asynchronous readahead operations to the storage server.

12. A storage server, comprising:
a management unit for receiving a stream generation request from a client and inserting the stream generation request into a queue of a management request processing unit in a distributed file system;
the management request processing unit for sending a stream identifier and information about an I/O worker, which correspond to the stream generation request, to the client, receiving a read request from the client, and inserting the read request into a queue of an I/O worker corresponding to the read request; and
an I/O worker for performing adaptive prefetching for the read request using an identifier of a file object of stream information corresponding to the read request and transmitting data that is read by performing adaptive prefetching to the client.

13. The storage server of claim 12, wherein the management request processing unit generates a file object including a prefetched context by opening a file corresponding to a stream generated by the client, generates stream information related to an identifier of the generated file object and the stream identifier, and selects an I/O worker to take exclusive charge of an individual stream corresponding to the stream identifier.

14. The storage server of claim 13, wherein the management unit receives a stream deletion request from the client and deletes the file object including the prefetched context by closing an identifier of a file object of a stream corresponding to the stream deletion request.

15. The storage server of claim 12, wherein the management unit calculates a required processing time, which is a time taken for the management request processing unit to process the stream generation request, and transmits result information of the stream generation request to the client, the result information including at least one of the stream identifier, the I/O worker information, information about the required processing time, and dummy data.

16. The storage server of claim 15, wherein the client calculates a required request-response time, which is a time taken to receive the result information of the stream generation request after sending the stream generation request, and calculates a maximum number of asynchronous readahead operations based on the required request-response time and the required processing time.

17. The storage server of claim 15, wherein the management request processing unit transmit the dummy data, the stream identifier, and the I/O worker information to the client, wherein the dummy data has a size identical to a readahead size of a storage device connected to the storage server.

18. The storage server of claim 12, wherein the management request processing unit receives a read request corresponding to a maximum number of asynchronous readahead operations from the client, which calculates the maximum number of asynchronous readahead operations based on at least one of a network delay time between the client and the storage server and information about a storage device connected to the storage server.

19. The storage server of claim 12, wherein the management request processing unit inserts the read request into a queue of an I/O worker that takes exclusive charge of an individual stream corresponding to the stream identifier of the read request, among multiple I/O workers, and then allows the I/O worker to process the read request.

20. The storage server of claim 19, wherein the management request processing unit receives the read request that includes at least one of the stream identifier, information about the I/O worker that takes exclusive charge of the individual stream corresponding to the stream identifier, readahead position information, and readahead size information.
